(19) United States
(12) Patent Application Publication
(10) Pub. No.: US 2012/0129364 A1
(43) Pub. Date: May 24, 2012

(54) ELECTRIC CONTACT AND SOCKET FOR ELECTRICAL PARTS

(75) Inventor: Yuki UEYAMA, Saitama (JP)

(73) Assignee: Enplas Corporation, Saitama (JP)

(21) Appl. No.: 13/292,159

(22) Filed: Nov. 9, 2011

(30) Foreign Application Priority Data
Nov. 18, 2010 (JP) 2010-257976

(51) Int. Cl. H01R 12/71; H01R 13/15

(52) U.S. Cl. 439/84; 439/259

(57) ABSTRACT

An electric contact which can improve the connection stability without increasing the sliding resistance even when the amount of reduction in the lengths of the electric contact is little. A preferred embodiment of the present invention comprises a first plunger which has conductivity and has an external cylinder portion; a second plunger which has internal contact portion to be inserted into the external cylinder portion, is interlinked with the first plunger in an extensible manner and has conductivity; and a coil spring which urges the first and second plungers toward a direction to separate them. The internal contact portion has a taper shape which expands towards the lower end from the upper end, and is formed so as to contact with the internal surface of the external cylinder portion and conduct to the external cylinder portion.

### BACKGROUND OF THE INVENTION

1. Field of the Invention

The present invention relates to an electric contact that is connected to an electrical part such as a semiconductor device (hereinafter, called an “IC package”), and related to a socket for electrical parts onto which the electric contact is located.

2. Description of the Prior Art

Conventionally, the IC socket, which accommodates the IC package as an “electrical part” removably, is known as the above-mentioned “socket for an electrical part”.

The conventional IC package comprises a package body which has a rectangular shape, for example, and has terminals.

On the other hand, the conventional IC socket comprises socket body to be located on the wiring substrate. The socket body is provided with a contact pin unit comprising a plurality of contact pins for electrically connecting the terminals of the IC package and the wiring substrate.

In addition, the socket body comprises a floating plate located so as to be vertically movable under the state of being urged upward by springs, and the IC package is accommodated on the floating plate.

When the IC socket is located on the wiring substrate and is used, the floating plate accommodates the IC package on itself and moves downward by being pressed from above.

Then, the upper side contact portions of the contact pins are pressed to the terminals of the IC package via the through holes formed in the floating plate, while the lower contact portions of the contact pins are pressed to the electrodes of the wiring substrate.

Under such situation, the electrical currents flow between the wiring substrate and the IC package through the contact pins, and a burn-in test etc. is performed.

As such contact pins, an electrical contact, in which a cylindrical first plunger (i.e. barrel) and a rod-shaped second plunger (i.e. plunger) is interlinked in an extensible manner via an urging member (i.e. spring), has been proposed (see Japanese laid-open patent publication 2010-91436).

### SUMMARY OF THE INVENTION

An object of the present invention is to provide an electric contact and a socket for electrical part in which the connection stability can be enhanced without increasing the sliding resistance even when the amount of reduction is small.

The first aspect of the present invention relates to an electric contact comprising; a first contact member which has conductivity and has an external cylinder portion; a second contact member which has internal contact portion to be inserted into the external cylinder portion, is interlinked with the first contact member in an extensible manner and has conductivity; and an urging member which urges the first contact member and the second contact member toward a direction to separate the first contact member and the second contact member; wherein the internal contact portion has a taper shape which expands from an end of being inserted into the first contact member toward the other end, and is formed so as to contact with the internal surface of the external cylinder portion and conduct to the external cylinder portion.

In the first aspect of the present invention, it is preferable that the urging member is a coil spring located inside of the external cylinder portion in an extensible manner, and one end of the coil spring is contacted to one end of the internal contact portion.

In the first aspect of the present invention, it is preferable that the first contact member comprises a first contact portion, an inner diameter of which is shorter than a diameter of the coil spring.

In the first aspect of the present invention, it is preferable that the other end of the coil spring is contacted to a step portion formed at a connection portion between the external cylinder portion and the first contact portion.

The second aspect of the present invention relates to a socket for an electrical part comprising: a socket body which is located on a wiring substrate and accommodates an electrical part on an upper side thereof, plural electric contacts which are located in the socket body, wherein the electric contact comprises; a first contact member which has conductivity and has an external cylinder portion, a second contact member which has internal contact portion to be inserted into the external cylinder portion, is interlinked with the first contact member in an extensible manner and has conductivity, and an urging member which urges the first contact member and the second contact member toward a direction to separate the first contact member and the second contact member, wherein the electric contact contacts to the electrical part at one of the first and second contact members, and contacts to the wiring substrate at the other of the first and second contact members, and wherein the internal contact portion has a taper shape which expands from an end of being inserted into the first contact member toward the other end, and is formed so as to contact with the internal surface of the external cylinder portion and conduct to the internal surface of the external cylinder portion.

In the second aspect of the present invention, it is preferable that the urging member is a coil spring located inside of the external cylinder portion in an extensible manner, and one end of the coil spring is contacted to one end of the internal contact portion.

In the second aspect of the present invention, it is preferable that the first contact member comprises a first contact portion, an inner diameter of which is shorter than a diameter of the coil spring.

In the second aspect of the present invention, it is preferable that the other end of the coil spring is contacted to a step portion formed at a connection portion between the external cylinder portion and the first contact portion.

According to the first and second aspects of the present invention, the connection stability can be enhanced without increasing the sliding resistance even when the amount of reduction in the lengths of the electric contact is small, because the internal contact portion, which is inserted into the external cylinder portion of the first contact member, has the taper shape.

According to the other characteristics of the first and second aspects of the present invention, a coil spring of simple structures can be used as the urging members, because any special structures of the urging member are not required.

### BRIEF DESCRIPTION OF THE DRAWINGS

Other objects and purposes of the present invention are described with referencing the following attached drawings.

FIG. 1 is an elevation view showing the IC socket according to an embodiment of the present invention.

FIG. 2A is an elevation view showing the contact pin before being stroked according to the same embodiment.

FIG. 2B is a cross-section view showing the contact pin before being stroked according to the same embodiment.

FIG. 3A is an elevation view showing the contact pin after being stroked according to the same embodiment.

FIG. 3B is a cross-section view showing the contact pin after being stroked according to the same embodiment.

FIG. 4 is a cross-section view showing a state that the IC socket is mounted on the wiring substrate to give an explanation on how to use the IC socket according to the same embodiment.

FIG. 5 is a cross-section view showing a state that the IC package is mounted on the IC socket and is pressed downward to give an explanation on how to use the IC socket according to the same embodiment.

FIGS. 6A to 6C are cross-section pattern diagrams showing a conduction of the contact pin according to the same embodiment.

FIGS. 7A and 7B are cross-section pattern diagrams showing a stroke of the contact pin according to the same embodiment.

FIGS. 8A to 8C are cross-section pattern diagrams showing a conduction of the contact pin according to a comparative example.

FIGS. 9A and 9B are cross-section pattern diagrams showing a stroke of the contact pin according to a comparative example.

### DETAILED DESCRIPTION

### A COMPARATIVE EXAMPLE

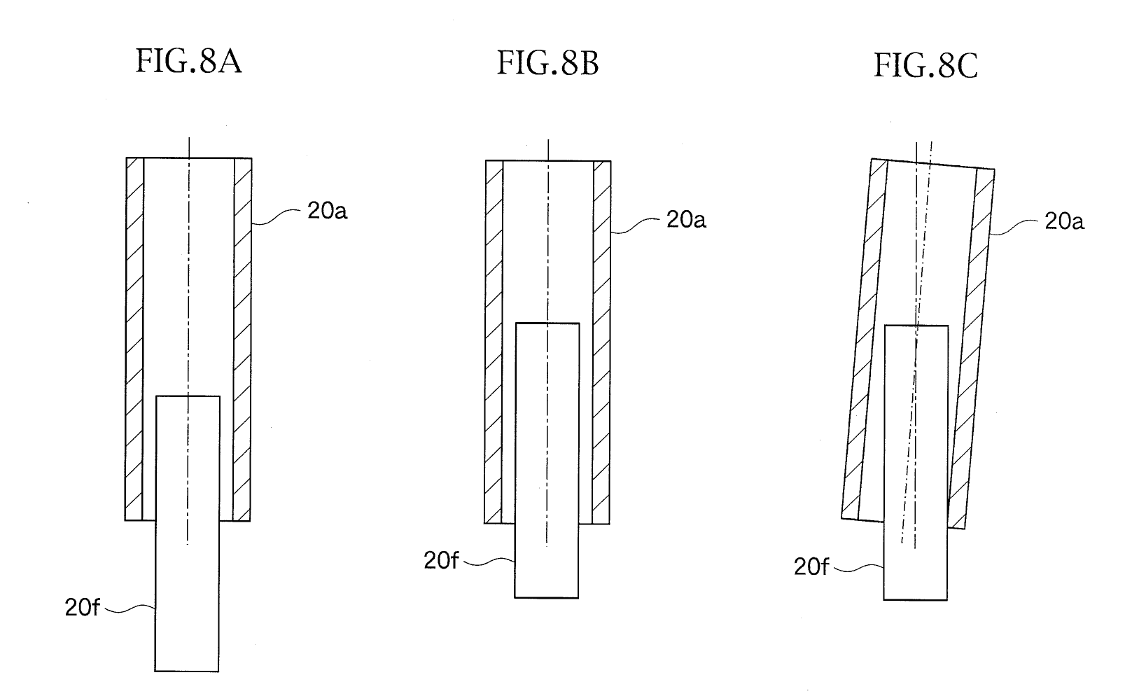

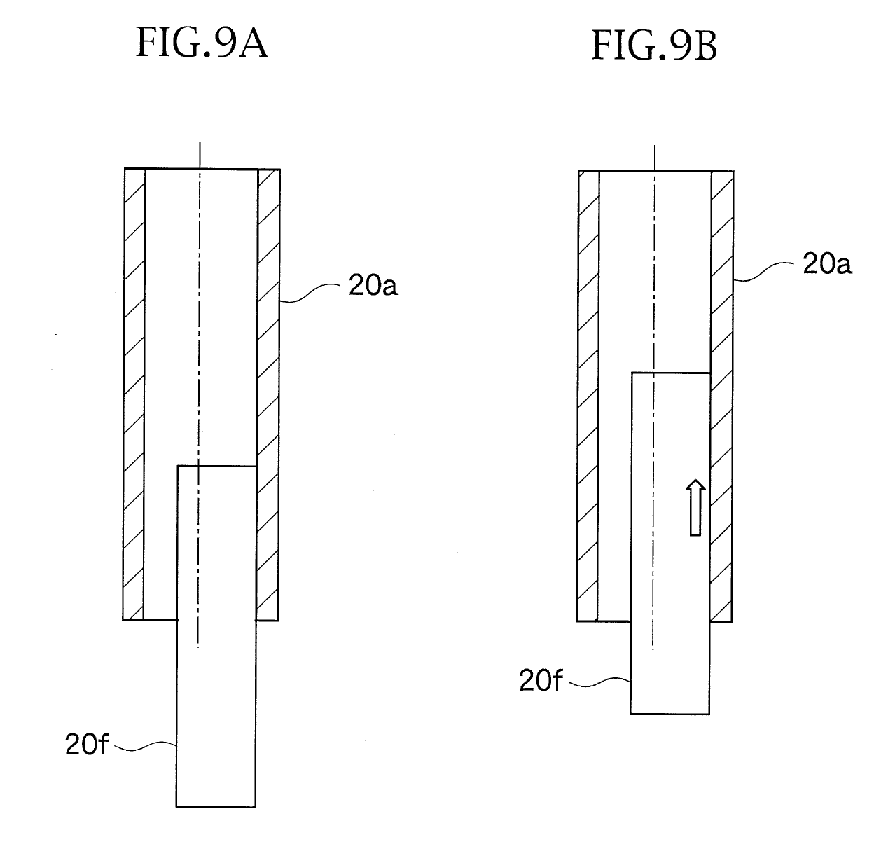

FIGS. 8A to 9B show a comparative example for making easier to understand the electrical contact according to the present invention.

The electrical contact shown in FIGS. 8A to 9B has following problems because the shape of the second plunger is a rod, that is, straight.

Firstly, as shown in FIGS. 8A and 8B, the first plunger 20a and the second plunger 20f do not stably contact each other if the plungers 20a and 20f are positioned on the same axis and the amount of reduction in the length of the electrical contact is too small. Therefore, the second plunger 20f needs to be inclined against the first plunger 20a to ensure the connection stability between them (see FIG. 8C). However, if the inclination of the second plunger 20f against the first plunger 20a becomes larger, the sliding resistance becomes larger and so the movement of the electric contact become weighted, consequently, the elastic force of the spring are being used wastefully.

Otherwise, it is presumable to make the diameter of the straight shape second plunger 20f larger for approximating the second plunger 20a to the inner surface of the first plunger 20a as much as possible, so that the inclination of the second plunger 20f against the first plunger 20a becomes smaller while ensuring the connection stability between the first plunger 20a and the second plunger 20f. However, such structure causes an increase of the frictional force between the first plunger 20a and the second plunger 20f, and so causes peelings of the plating of the first and second plungers 20a and 20f. In addition, the increase of the frictional force causes an increase in the sliding resistance and an increase in the weight of movement of the electrical contact. Consequently, such structure has no practical use.

As shown in FIG. 9A and 9B, if the second plunger 20f moves in parallel fashion to the first plunger 20a and contacts it (see FIG. 9A), the horizontal load between the first and second plunger 20a and 20f rarely occurs when the second plunger 20f is inserted into the first plunger 20a (see FIG. 9B), and so the connection stability between the first and second plungers 20a and 20f is poor.

### An Embodiment of the Invention

A preferred embodiment of the present invention is described hereinafter.

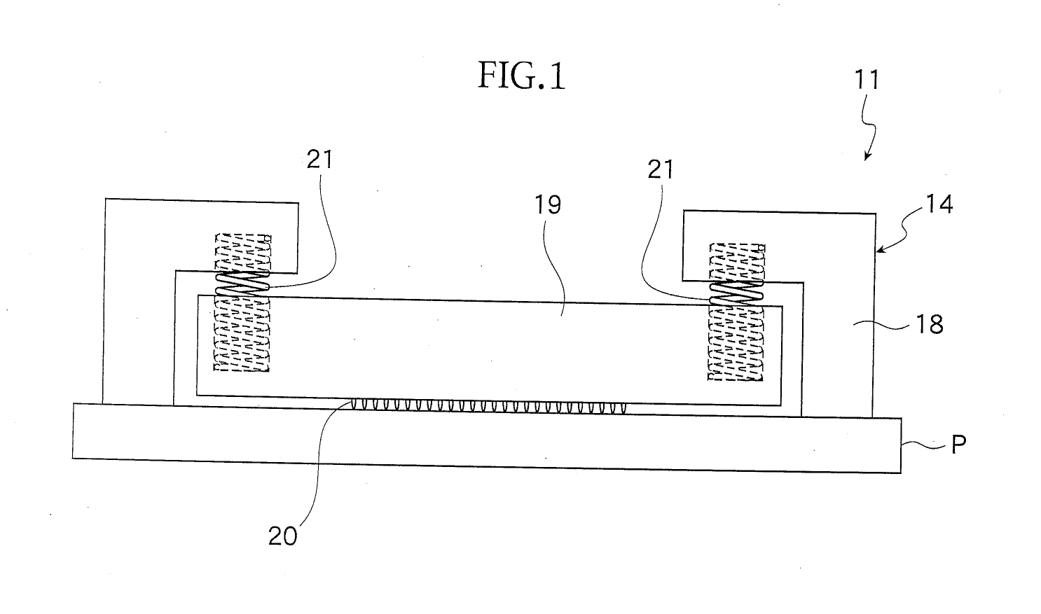

FIGS. 1 to 7B show the embodiment of the present invention.

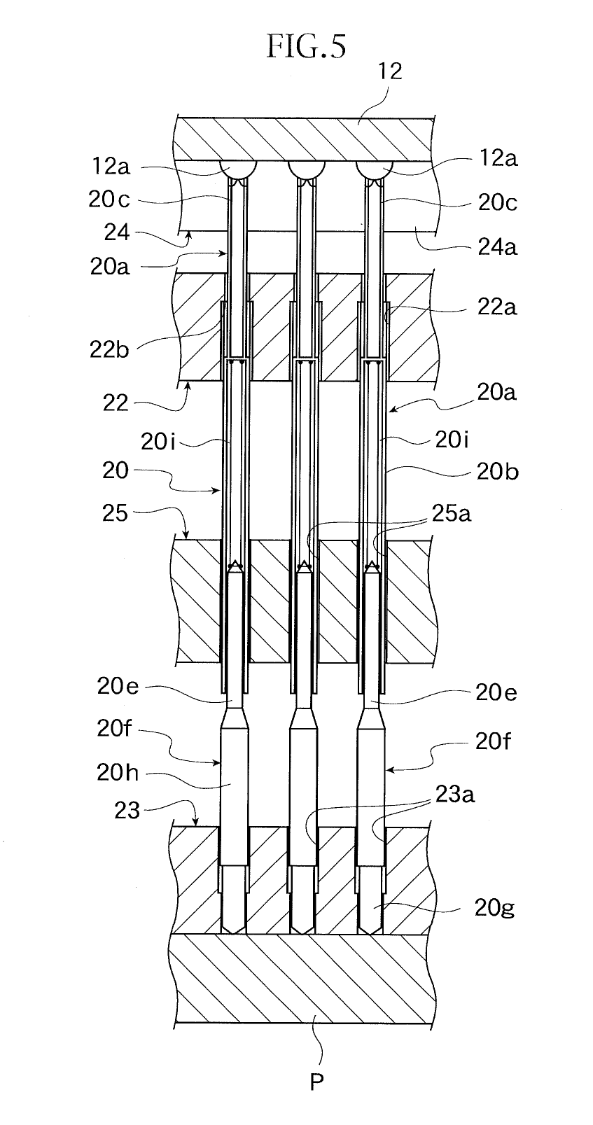

Firstly, the constitution of the present embodiment is described. In FIG. 1, the symbol 11 corresponds to the IC socket as “socket for electrical part”. The IC socket 11 is located on the wiring substrate P. The spherical terminals 12a of the IC package 12 and the wiring substrate P are electrically connected for performing the burn-in test etc. of the IC package 12 (see FIG. 5) as “electrical part”.

As shown in FIG. 1, the IC socket 11 comprises the socket body 14 which is fixed on the wiring substrate P and accommodates the IC package 12.

In detail, the socket body 14 comprises the external frame 18 of rectangular frame shape in which the contact module 19 is located, and the springs 21 located between the external frame 18 and the contact module 19.

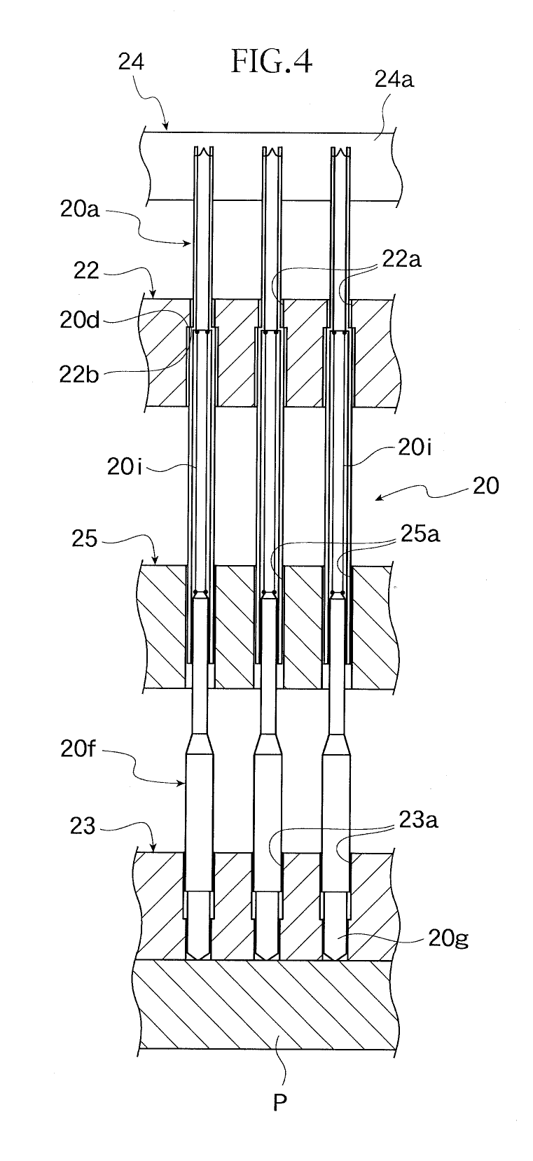

In the contact module 19, plural contact pins 20 as the “electrical contact” are provided. The IC package 12 is accommodated on the upper side of the contact module 19. As shown in FIG. 4, the contact module 19 comprises the upper side holding member 22, the middle holding member 25, the lower side holding member 23, the floating plate 24 and so on. The upper side holding member 22, the middle holding member 25 and the lower side holding member 23 are held at predetermined intervals. The floating plate 24 is located above the upper side holding member 22 and is urged upward by the springs not shown in FIG. 4. And the contact pins 20 are located under the state of being inserted into the through holes 22a, 25a, 23a and 24a of the upper side holding member 22, the middle holding member 25, the lower side holding member 23 and the floating plate 24.

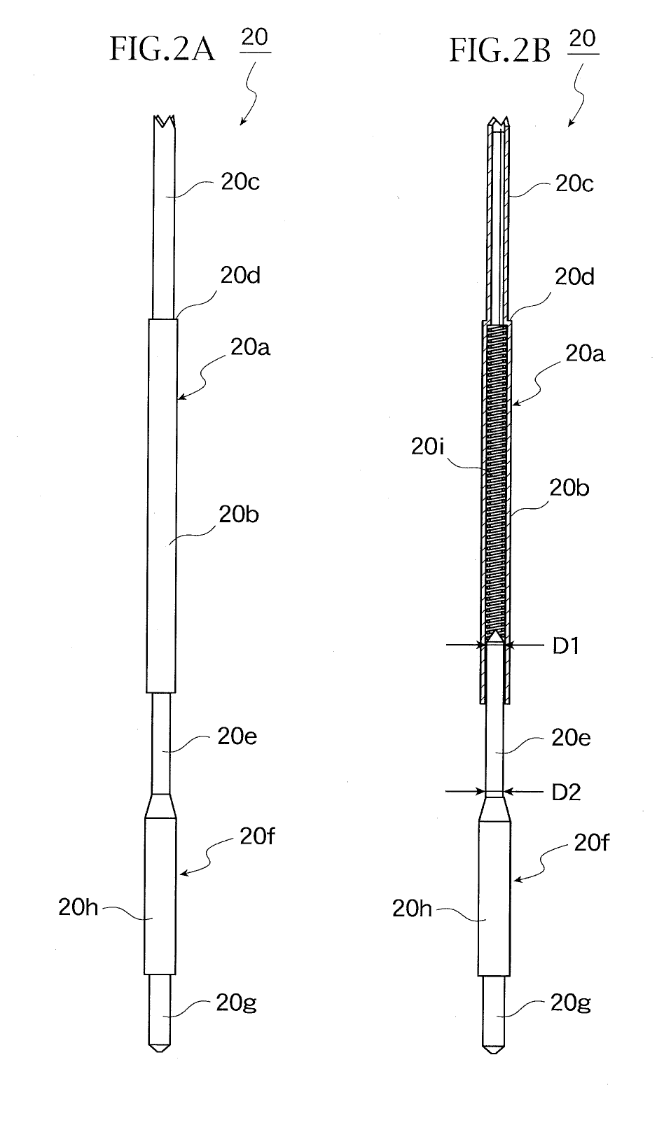

As shown in FIGS. 2A and 2B, each of the contact pins 20 comprises the first plunger 20a as the “first contact member”, the second plunger 20f as the “second contact member” and the coil spring 20i as the “urging member”. The first plunger 20a has conductivity, has cylindrical shape and has a step portion. The second plunger 20f has conductivity, has a shape of rod and has a step portion.

The first plunger 20a is provided with the external cylinder portion 20b having the internal diameter longer than the external diameter of the coil spring 20i, the first contact portion 20c having the internal diameter shorter than the external diameter of the coil spring 20i, and the step portion 20d to connect the external cylinder portion 20b and the first contact portion 20c. The first contact portion 20c is made to be contacted with the spherical terminal 12a of the IC package 12 (see FIG. 5). The first plunger 20a is made by bending a flat conductive plate cylindrically and forming a step. Therefore, it is easy to make contact pins 20 very thin.

The second plunger 20f is provided with the body portion 20h having the external diameter longer than the internal diameter of the external cylinder portion 20b (e.g. 0.27 millimeter) of the first plunger 20a, the second contact portion 20g having the external diameter shorter than the external diameter of the body portion 20h and the internal contact portion 20e having the external diameter shorter than the internal diameter of the external cylinder portion 20b of the first plunger 20a. The internal contact portion 20e is inserted into the external cylinder portion 20b of the first plunger 20a vertically movable. As shown in FIG. 2B, the internal contact portion 20e has a taper shape which expands towards the lower end (i.e. the end side the body portion 20h) from the upper end (the end of being inserted into the first plunger 20a), and so the diameter D2 of the lower end (e.g. 0.24 millimeter) is longer than the diameter D1 of the upper end (e.g. 0.22 millimeter). And the internal contact portion 20e is formed so as to contact with the internal surface of the external cylinder portion 20b and conduct to it.

The coil spring 20i is inserted into the external cylinder portion 20b of the first plunger 20a. The upper end of the coil spring 20i contacts to the step portion 20d of the first plunger 20a, and the lower end of the coil spring 20i contacts to one end of the internal contact portion 20e of the second plunger 20f. Consequently, the coil spring 20i urges the second plunger 20f downward.

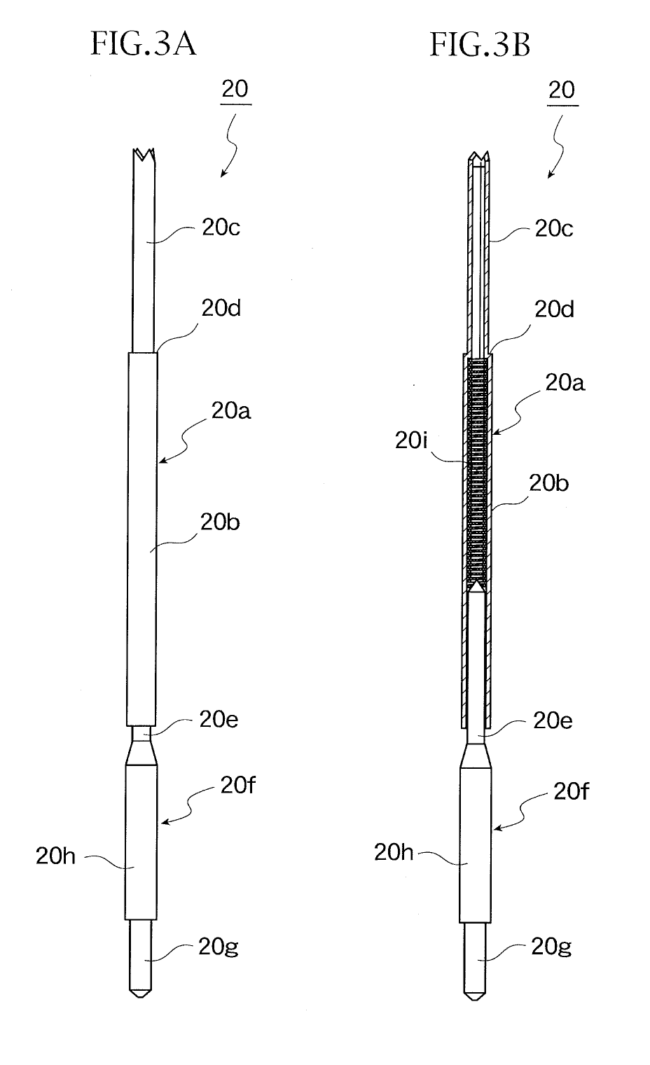

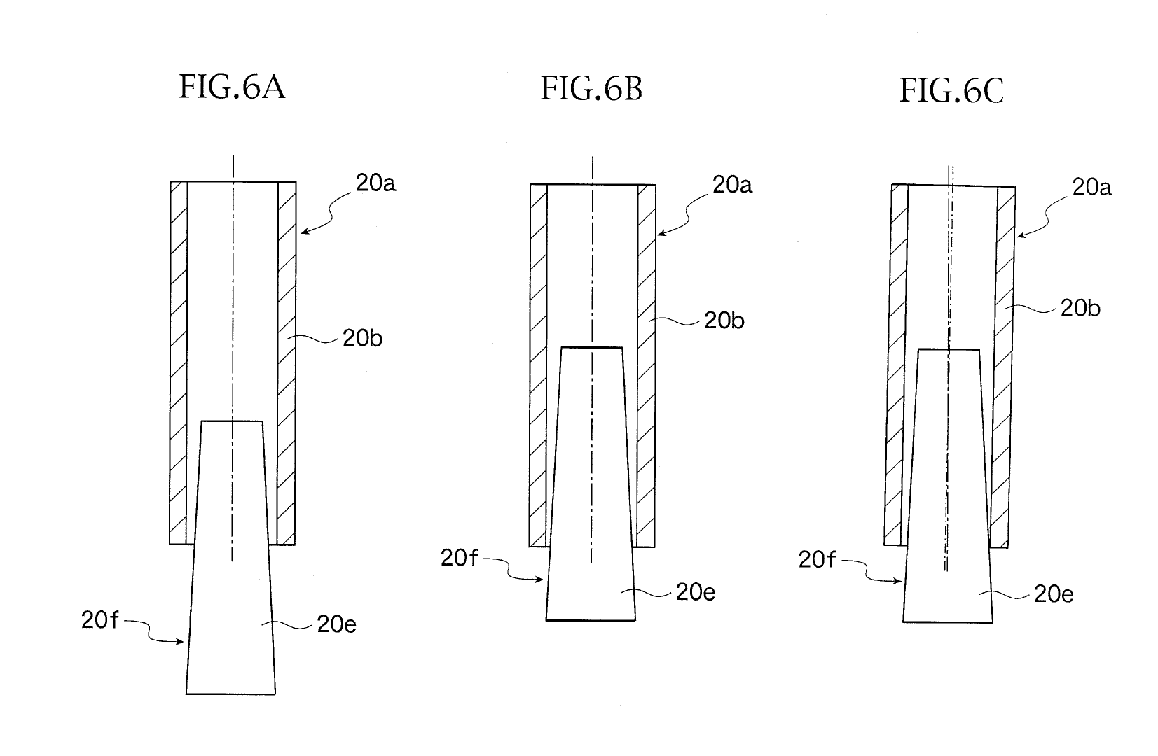

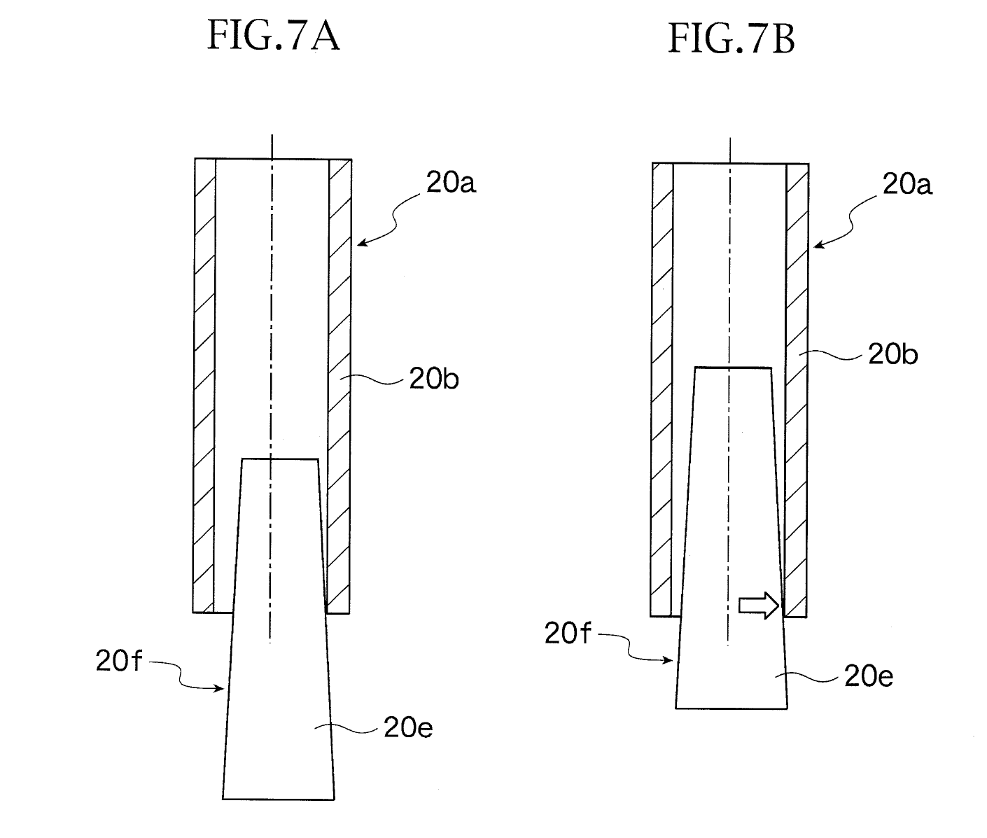

Next, a way to use the IC socket 11 is described using FIGS. 3 to 7B. Incidentally, as shown in FIG. 2B and so on, the internal contact portion 20e according to the present embodiment comprises a sonically-shaped end portion, however, the end portion is omitted in FIGS. 6A to 7B.

Firstly, the IC socket 11 is mounted onto the wiring substrate P. As shown in FIG. 4, before mounting the IC package 12 onto the IC socket 11, the step portions 20d of the first plungers 20a are engaged with the step portions 20b of the through holes 22a of the upper side holding member 22, and so the first plungers 20a are positioned to the top. In such situation, the second plungers 20f contact to the electrodes, which are not shown in Figures, of the wiring substrate P and are pushed upward by the electrodes. The coil springs 20i, which are located in the external cylinder portion 20b of the first plunger 20a, shrink a little in such situation.

When the IC package 12 is mounted onto the IC socket 11 and is pressed downward, the floating plate 24 falls against the urging force of the spring 21, as shown in FIG. 5. Consequently, the spherical terminals 12a of the IC package 12 contact to the first contact portions 20c of the first plungers 20a and push the first plungers 20a. As a result, the first plunger 20a are pushed downward against the urging force of the coil spring 20i (see FIGS. 3A and 3B), and so the internal contact portions 20e of the second plungers 20f contact with the internal surfaces of the external cylinder portions 20b of the first plungers 20a, and conduct to them.

As described above, the internal contact portions 20e have taper shapes which expand from the upper end towards the lower end, and so, the distances between the external cylinder portions 20b and the internal contact portions 20e are very narrow as shown in FIGS. 6A to 6C. Therefore, the external cylinder portions 20b and the internal contact portions 20e can contact and conduct each other even if the internal contact portions 20e lean toward the external cylinder portions 20b only a little. As a result, the connection stabilities can be improved without increasing the sliding resistances between the internal contact portions 20e and the external cylinder portions 20b, even when the amount of reduction in the lengths of the contact pins 20 are small.

As shown in FIGS. 7A and 7B, the external surfaces of the internal contact portions 20e do not become parallel with the internal surfaces of the external cylinder portions 20b when the internal contact portions 20e are inserted into the external cylinder portions 20b, so the lower position of the gaps between these surfaces are narrower. Therefore, the loads of horizontal directions occur at the contact place between the internal contact portions 20e and the external cylinder portion 20b (see the directing arrow in FIG. 7B), and so the connection stabilities between these portions 20e and 20b improve.

In this way, the spherical terminals 12a of the IC package 12 and the electrodes of the wiring substrate P are electrically connected through the contact pins 20. Then, the electric currents are supplied to the IC package 12 and a burn-in test and so on are performed in such state.

As described above, the present embodiment improves the connection stabilities between the internal contact portions 20e and the external cylinder portions 20b by devising the forms of the internal contact portions 20e of the second plungers 20f, and so any special structures of the urging members for separating these portions 20e and 20b are not required. Therefore, the coil springs 20i of simple structures can be used as the urging members.

Incidentally, above mentioned embodiment is used under the state that the cylindrical first plungers 20a provided with step portions are positioned at the upper sides and the round-rod-shaped second plungers 20f provided with step portions are positioned at the lower sides. However, the electric contact according to the present invention can be used under the state that the second plunger 20f is positioned at the upper side and the first plunger 20a is positioned at the lower side.

In the case of above mentioned embodiment, the present invention is applied to the IC socket 11 as “socket for electrical part”, however, it is clear that the present invention can be applied to other kinds of devices.

Additionally, the present invention can be applied to the IC socket called the “open top type” or the “clam shell type”, moreover, can be applied to the test apparatus in which the pusher for pushing the electrical part is located at the side of the automated instrument.

What is claimed is:

1. An electric contact comprising;
a first contact member which has conductivity and has an external cylinder portion,
a second contact member which has internal contact portion to be inserted into the external cylinder portion, is interlinked with the first contact member in an extensible manner and has conductivity, and
an urging member which urges the first contact member and the second contact member toward a direction to separate the first contact member and the second contact member,
wherein the internal contact portion has a taper shape which expands from an end of being inserted into the first contact member toward the other end, and is formed so as to contact with the internal surface of the external cylinder portion and conduct to the external cylinder portion.

2. The electric contact according to claim 1, wherein;
the urging member is a coil spring located inside of the external cylinder portion in an extensible manner, and
one end of the coil spring is contacted to one end of the internal contact portion.

3. The electric contact according to claim 2, wherein the first contact member comprises a first contact portion, an inner diameter of which is shorter than a diameter of the coil spring.

4. The electric contact according to claim 3, wherein the other end of the coil spring is contacted to a step portion formed at a connection portion between the external cylinder portion and the first contact portion.

5. A socket for an electrical part, comprising:
a socket body which is located on a wiring substrate and accommodates an electrical part on an upper side thereof,
plural electric contacts which are located in the socket body,
wherein the electric contact comprises;
a first contact member which has conductivity and has an external cylinder portion,
a second contact member which has internal contact portion to be inserted into the external cylinder portion, is interlinked with the first contact member in an extensible manner and has conductivity, and
an urging member which urges the first contact member and the second contact member toward a direction to separate the first contact member and the second contact member,
wherein the electric contact contacts to the electrical part at one of the first and second contact members, and contacts to the wiring substrate at the other of the first and second contact members, and
wherein the internal contact portion has a taper shape which expands from an end of being inserted into the first contact member toward the other end, and is formed so as to contact with the internal surface of the external cylinder portion and conduct to the external cylinder portion.

6. The socket for an electrical part according to claim 5, wherein;
the urging member is a coil spring located inside of the external cylinder portion in an extensible manner, and
one end of the coil spring is contacted to one end of the internal contact portion.

7. The socket for an electrical part according to claim 6, wherein the first contact member comprises a first contact portion, an inner diameter of which is shorter than a diameter of the coil spring.

8. The socket for an electrical part according to claim 7, wherein the other end of the coil spring is contacted to a step portion formed at a connection portion between the external cylinder portion and the first contact portion.
